(19) United States
(12) Patent Application Publication
(10) Pub. No.: US 2017/0171123 A1
(43) Pub. Date: Jun. 15, 2017

(54) METHOD AND DEVICE FOR EMAIL PROCESSING

(71) Applicants: Le Holdings (Beijing) Co., Ltd., Beijing (CN); Lemobile Information Technology (Beijing) Co., Ltd., Beijing (CN)

(72) Inventor: Xunhu GUI, Beijing (CN)

(21) Appl. No.: 15/250,883

(22) Filed: Aug. 29, 2016

Related U.S. Application Data
(63) Continuation of application No. PCT/CN2016/088921, filed on Jul. 6, 2016.

(30) Foreign Application Priority Data
Dec. 12, 2015 (CN) 201510921364.8

(51) Int. Cl. H04L 12/58; H04L 29/12

(52) U.S. Cl. CPC H04L 51/08; H04L 51/046; H04L 51/16; H04L 61/1564

(57) ABSTRACT

Disclosed are an email processing method and device. The method includes: acquiring attachments of all the emails in a predetermined file folder of an email account; and determining emails corresponding to the attachments; exhibiting the attachments of all the emails in a first predetermined manner; and processing links of the emails corresponding to the attachments, such that a user is capable of performing operations for the corresponding emails via the links. With the email processing method and device according to the embodiments of the present disclosure, while attachments in a predetermined file folder of an email account are exhibited in a list form, links of emails corresponding to the attachments are provided, such that a user is capable of performing operations for the emails via the links corresponding to the emails while checking the attachments.

### CROSS REFERENCE TO RELATED APPLICATIONS

This application is a continuation of International Application No. PCT/CN2016/088921, filed on Jul. 6, 2016, which claims priority to Chinese Patent Application No. 201510921364.8, filed on Dec. 12, 2015, the entire contents of which are incorporated herein by reference.

### TECHNICAL FIELD

The disclosure relates to the technical field of communications, and more particularly, to a method and device for email processing.

### BACKGROUND

In the era of the Internet, emails have replaced the paper mails and become an indispensable part in email communications. Any devices capable of connecting to the network may send and receive emails. In addition, regardless of whether the network is a cellular network, there are a plurality of types of devices which are capable of sending and receiving emails, including computers, mobile terminals, for example, mobile phones, PADs, wearable devices and the like. It should be understood that no matter which terminal is used, processing of the emails may be similar.

For example, using mobile devices as an example, mobile phones nowadays are used by people as necessities, and within a drastic increase of the number of smart phones, functions of the mobile phone are not still restricted to making calls, sending and receiving short messages and the like basic functions, the mobile officing function of the smart terminals is gradually prominent. Convenience and practicability of mobile phone emails are fascinating commercial and business persons who need to search for in real time and intelligently in thousands of emails each day.

At present, email boxes are not intended to merely sending emails and checking email content; in addition, attachments are becoming an important part of the emails. In the related art, most of the mobile phone email boxes exhibit attachments in individual emails, that is, exhibiting an attachment and an email thereof as an integrity. Some mobile phone email boxes exhibit all the attachments once in the form of an independent attachment list, that is, exhibiting all the attachments in a file folder in an email box, instead of exhibiting the attachments together with the email content.

No matter individually exhibition of the attachments or exhibition of the attachments once, in practice application, some problems may be more or less encountered. In individual exhibition of an email, the email content of the email may be integrally exhibited, including text content and attachment content of the email. However, sometimes, a user only desires to know the attachment content, and thus would not the email corresponding to the attachment. Accordingly, an approach of exhibiting all the attachments by adding a page of an attachment list is proposed. Operations for the attachments are generally browsing, forwarding, sharing and the like. However, sometimes, upon checking an attachment, the user needs to check the corresponding email. In this case, the user needs to find the email corresponding to the attachment among masses of emails.

Upon checking the attachments in a manner of exhibiting all the attachments once, the user needs to search for text content of the emails corresponding to the attachments, or needs to perform such operations for the emails as forwarding or replying or marking. In this case, the user needs to return to the email list to find the email one by one. This process is time and labor consuming, and causes inconvenience in operability to the user.

### SUMMARY

Embodiments of the present disclosure provide a method and device for email processing, which are capable of conveniently finding emails corresponding to attachments after a user checks the attachments in a separate attachment list.

An embodiment of the present disclosure provides an email processing method, including: acquiring attachments of all the emails in a predetermined file folder of an email account; and determining emails corresponding to the attachments; exhibiting the attachments of all the emails in a first predetermined manner; and processing links of the emails corresponding to the attachments, such that a user is capable of performing operations for the corresponding emails via the links.

An embodiment of the present disclosure provides an email processing device, including: at least one processor; and a memory communicably connected with the at least one processor for storing instructions executable by the at least one processor, wherein execution of the instructions by the at least one processor causes the at least one processor to: acquire attachments of all the emails in a predetermined file folder of an email account; determine emails corresponding to the attachments; exhibit the attachments of all the emails in a first predetermined manner; and process links of the emails corresponding to the attachments, such that a user is capable of performing operations for the corresponding emails via the links.

An embodiment of the present disclosure further provides a non-transitory computer-readable storage medium storing executable instructions that, when executed by an electronic device, cause the electronic device to: acquire attachments of all the emails in a predetermined file folder of an email account; determine emails corresponding to the attachments; exhibit the attachments of all the emails in a first predetermined manner; and process links of the emails corresponding to the attachments, such that a user is capable of performing operations for the corresponding emails via the links.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating an email processing method according to one embodiment of the present disclosure;

FIG. 2 is a flowchart illustrating an email processing method according to another embodiment of the present disclosure;

FIG. 3 is a flowchart illustrating an email processing method according to still another embodiment of the present disclosure;

FIG. 4 is a flowchart illustrating an email processing method according to yet another embodiment of the present disclosure;

FIG. 5 is a schematic diagram illustrating a specific implementation effect of the email processing method according to the embodiments of the present disclosure;

FIG. 6 is a schematic structural diagram illustrating an email processing device according to one embodiment of the present disclosure;

FIG. 7 is a schematic structural diagram illustrating an email processing device according to another embodiment of the present disclosure;

FIG. 8 is a schematic structural diagram illustrating an email processing device according to still another embodiment of the present disclosure; and

FIG. 9 is a schematic structural diagram illustrating an email processing device according to yet still another embodiment of the present disclosure.

FIG. 10 is a schematic structural diagram illustrating an electronic device according to the present disclosure.

### DETAILED DESCRIPTION

To make the objectives, technical solutions and advantages of the embodiments of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

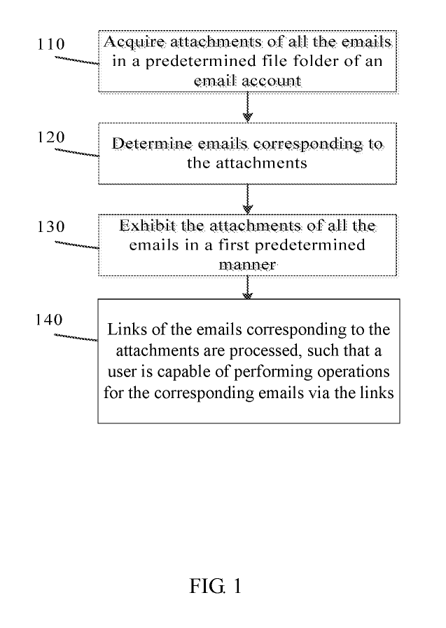

FIG. 1 is a flowchart illustrating an email processing method according to one embodiment of the present disclosure. As illustrated in FIG. 1, the email processing method according to the present disclosure includes the following steps:

Step 110: Attachments of all the emails in a predetermined file folder of an email account are acquired.

In the related art, when an email is received, an email server may acquire the time, sender, attachment name, attachment size and attachment of the email. In this step, attachments of all the emails in a predetermined file folder of an email account may be acquired from the email server.

Step 120: Emails corresponding to all the attachments are determined.

In this step, the emails corresponding to the attachments may be determined according to the attachments. It should be understood that each email stored in an email server has its own email serial number, wherein the serial number uniquely identifies the email. Likewise, each attachment stored in the email server has an email serial number to which the attachment pertains. Therefore, the serial number of the email to which the attachment pertains to may be firstly searched according to the attachment, and then the corresponding email is determined according to the serial number.

Step 130: The attachments of all the emails are exhibited in a first predetermined manner.

In this step, attachments of all the emails in a predetermined file folder of an email account may be exhibited in a separate email attachment list. For example, the attachments may be exhibited in sequence according to the sizes of the attachments, or may be exhibited in sequence according to the acquisition time of the attachments, or may be exhibited in sequence according to the names of the attachments. The first predetermined manner may include a plurality of manners in the related art.

Step 140: Links of the emails corresponding to the attachments are processed, such that a user is capable of performing operations for the corresponding emails via the links.

With respect to the links of the emails determined in step 120, for example, the links of the emails are displayed in the form of icons, such that the user is capable of performing operations for the email by operating the icons. For example, an icon under an item exhibiting an email attachment may be set, and the email may be checked by clicking this icon. In this case, the icon may display characters “check the email”, or characters indicating that the email may be checked via the icon. In practice, a link via which the email may be checked may be directly connected via this icon. Therefore, in this step, processing of the link of the email may be setting the link of the email in an icon; and when the user performs an operation for the icon, the link of the email is operated. In this way, the email may be directly checked, replied or forwarded.

According to the embodiment of the present disclosure, all the attachments are acquired, emails corresponding to the attachments are determined, and links of the emails are processed, such that a user is capable of performing operations for the emails via the links. In this way, while the user checks the attachments by using an attachment list, the user is further capable of checking the emails via attachment jumping, such that mutually linking and jumping between the email attachments and the email content, which facilitates user's checking the emails according to the attachments.

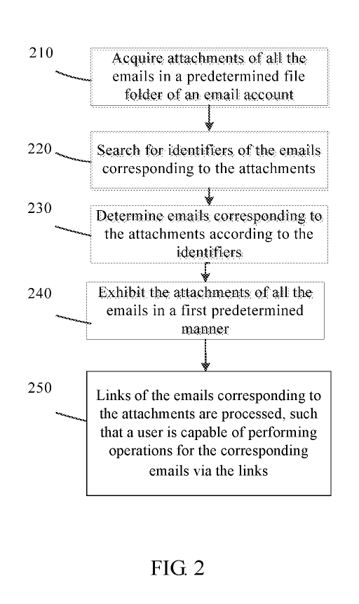

FIG. 2 is a flowchart illustrating an email processing method according to another embodiment of the present disclosure. As illustrated in FIG. 2, the email processing method according to the present disclosure includes the following steps:

Step 210: Attachments of all the emails in a predetermined file folder of an email account are acquired.

In this step, acquisition of the attachments of all the emails in the predetermined file folder of the email account may be referenced to step 110 in the embodiment illustrated in FIG. 1.

Step 220: Identifiers of the emails corresponding to the attachments are searched.

Specifically, since each attachment has an identifier of the email to which the attachment pertains, in this step, an email identifier of the attachment may be searched in an email server.

Step 230: Emails corresponding to the attachments are determined according to the identifiers.

In step 220, unique identifiers of the emails corresponding to the attachments are searched. Therefore, in this step, determining to which email an attachment pertains according to the unique identifier is equivalent to determining the email corresponding to the attachment.

Step 240: The attachments of all the emails are exhibited in a first predetermined manner.

In this step, the attachments of all the emails are exhibited the first predetermined manner. The details may be referenced to step 130 in the embodiment illustrated in FIG. 1.

Step 250: Links of the emails corresponding to the attachments are processed, such that a user is capable of performing operations for the corresponding emails via the links.

In this step, the attachments of all the emails are exhibited the first predetermined manner. The details may be referenced to step 140 in the embodiment illustrated in FIG. 1.

In the embodiment of the present disclosure, the email corresponding to an attachment is determined via an identifier of the email carried by the attachment. As such, the corresponding email may be acquired accurately via the attachment, and accuracy in searching for an email is enhanced.

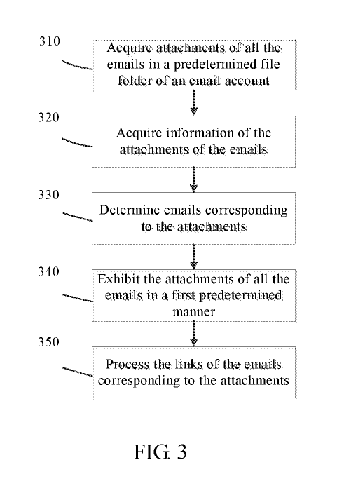

FIG. 3 is a flowchart illustrating an email processing method according to still another embodiment of the present disclosure. As illustrated in FIG. 3, the email processing method according to the present disclosure includes the following steps:

Step 310: Attachments of all the emails in a predetermined file folder of an email account are acquired.

In this step, acquisition of the attachments of all the emails in the predetermined file folder of the email account may be referenced to step 110 in the embodiment illustrated in FIG. 1.

Step 320: Information of the attachments of the emails is acquired, wherein the information includes one or a combination of: names of the attachments, sizes of the attachments, generation dates of the attachments, and senders of the attachments.

In this step, the information of the attachments may be acquired, via search, from information stored in an email server, wherein the information may include names of the attachments, sizes of the attachments, generation dates of the attachments, senders of the attachments and the like.

Step 330: Emails corresponding to the attachments are determined.

In this step, the emails corresponding to all the attachments are determined. The details may be referenced to step 120 in the embodiment illustrated in FIG. 1.

Step 340: The attachments of all the emails are exhibited in a first predetermined manner.

In this step, the attachments of all the emails are exhibited in the first predetermined manner, and the attachments may be exhibited in sequence according to the information acquired in step 320. For example, the attachments may be exhibited in sequence according to the names of the attachments, or may be exhibited in sequence according to the sizes of the attachments, or may be exhibited in sequence according to the senders of the attachments.

Step 350: Links of the emails corresponding to the attachments are processed, such that a user is capable of performing operations for the corresponding emails via the links.

In this step, the links of the emails corresponding to the attachments are processed, such that the user is capable of performing operations for the corresponding emails via the links. The details may be referenced to step 140 in the embodiment illustrated in FIG. 1.

In the embodiment of the present disclosure, information of attachments is acquired and the attachments are sequenced according to the information, which more facilitates user's searching for the attachments. In this way, a user is capable of searching for emails according to the attachments, and thus user experience in email use is further improved.

Specifically, the exhibiting the attachments of all the emails in a first predetermined manner in the embodiment of the present disclosure includes: exhibiting in sequence all the attachments according to the names of the attachments; or exhibiting in sequence all the attachments according to the sizes of the attachments; or exhibiting in sequence all the attachments according to the senders of the attachments; or exhibiting in sequence all the attachments according to the generation dates of the attachments.

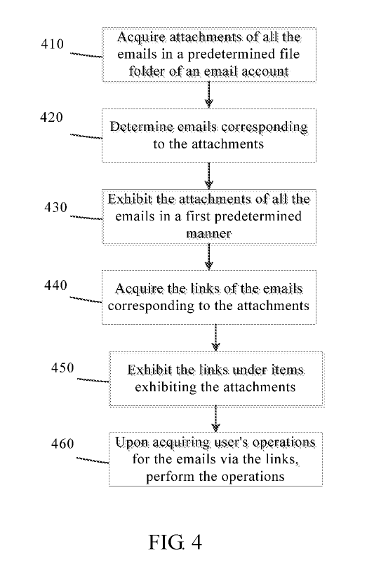

FIG. 4 is a flowchart illustrating an email processing method according to yet another embodiment of the present disclosure. As illustrated in FIG. 4, the email processing method according to the present disclosure includes the following steps:

Step 410: Attachments of all the emails in a predetermined file folder of an email account are acquired.

In this step, acquisition of the attachments of all the emails in the predetermined file folder of the email account may be referenced to step 110 in the embodiment illustrated in FIG. 1.

Step 420: Emails corresponding to the all the attachments are determined.

In this step, the emails corresponding to all the attachments are determined. The details may be referenced to step 120 in the embodiment illustrated in FIG. 1.

Step 430: The attachments of all the emails are exhibited in a first predetermined manner.

In this step, the attachments of all the emails are exhibited the first predetermined manner. The details may be referenced to step 130 in the embodiment illustrated in FIG. 1.

Step 440: The links of the emails corresponding to the attachments are acquired.

Since the emails corresponding to all the attachments are determined in step 420, in this step, the links of the emails are determined according to the determined emails. It should be understood that the links of the emails are to entering the links of the emails and thus perform operations for the emails by exhibiting the links of the emails.

Step 450: The links under items exhibiting the attachments are exhibited in a predetermined form.

It should be understood that during exhibition of the attachments, all the attachments may be exhibited in a list, and each attachment is exhibited via an attachment item. This item may include various information of the attachment, for example, size of the attachment, reception time of the attachment and the like. In this step, the link of the email corresponding to the attachment is also exhibited in the attachment. It is to be noted that in the present disclosure, the links of the emails are not necessarily directly exhibited, which are exhibited in various predetermined manners instead. For example, the user is notified via an icon that clicking the icon helps the user to jump to the link of the email, or such notification may be implemented via text. The present disclosure sets no limitation thereto.

Step 460: When it is detected that the user performs operations for the emails via the links exhibited in the predetermined form, the operations are performed.

When the user's operations for the emails via the links exhibited in the predetermined form are acquired, the operations are performed. For example, in step 450, the links of the emails are exhibited in the form of icons; and then in this step, when the user's operations for the icons are acquired, the operations are performed. Herein the operations may be checking the email, replying the email, forwarding the email or the like.

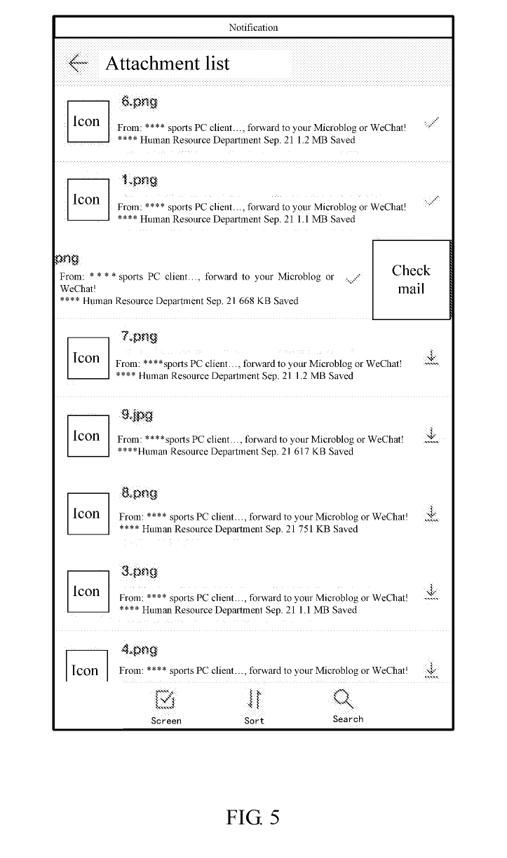

FIG. 5 is a schematic diagram illustrating a specific implementation effect of the email processing method according to the embodiments of the present disclosure. In FIG. 5, the left part illustrates a schematic diagram illustrating an effect of exhibiting attachments via an attachment list, and the right part illustrates a schematic diagram illustrating an effect of exhibiting links of emails via icons under attachment items and thus directly checking the emails via the icons.

In the embodiment of the present disclosure, links of emails are exhibited in a predetermined form under attachment items, such that a user is capable of directly checking corresponding emails under items of attachments while checking the attachments. This increases the convenience of the user in checking the emails via the attachments, and improves user experience.

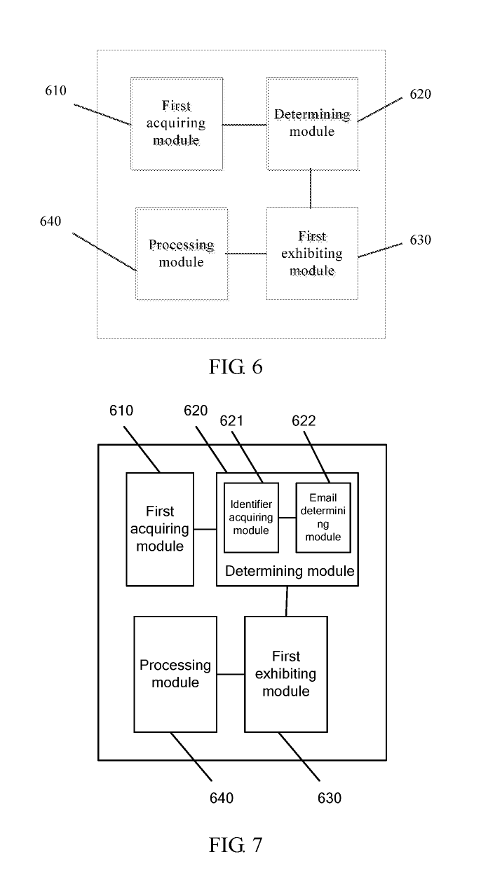

FIG. 6 is a schematic structural diagram illustrating an email processing device according to one embodiment of the present disclosure. As illustrated in FIG. 6, the email processing device according to the present disclosure includes: a first acquiring module 610, a determining module 620, a first exhibiting module 630, and a processing module 640.

The first acquiring module 610 is configured to acquire attachments of all the emails in a predetermined file folder of an email account.

In the related art, when an email is received, an email server may acquire the time, sender, attachment name, attachment size and attachment of the email. The first acquiring module 610 may acquire attachments of all the emails in a predetermined file folder of an email account from the email server.

The determining module 620 is configured to determine emails corresponding to the attachments.

The determining module 620 is configured to determine emails corresponding to the attachments according to the attachments. It should be understood that each email stored in an email server has its own email serial number, wherein the serial number uniquely identifies the email. Likewise, each attachment stored in the email server has an email serial number to which the attachment pertains. Therefore, the serial number of the email to which the attachment pertains to may be firstly searched according to the attachment, and then the corresponding email is determined according to the serial number.

The first exhibiting module 630 is configured to exhibit the attachments of all the emails in a first predetermined manner.

The first exhibiting module 630 may exhibit attachments of all the emails in a predetermined file folder of an email account in a separate email attachment list. For example, the attachments may be exhibited in sequence according to the sizes of the attachments, or may be exhibited in sequence according to the acquisition time of the attachments, or may be exhibited in sequence according to the names of the attachments. The first predetermined manner may include a plurality of manners in the related art.

The processing module 640 is configured to process links of the emails corresponding to the attachments, such that a user is capable of performing operations for the corresponding emails via the links.

With respect to the links of the emails determined by the determining module 620, the processing module 640 may display the links of the emails in the form of icons, such that the user is capable of performing operations for the email by operating the icons. For example, an icon under an item exhibiting an email attachment may be set, and the email may be checked by clicking this icon. In this case, the icon may display characters “check the email”, or characters indicating that the email may be checked via the icon. In practice, a link of the email may be directly connected via this icon. Processing of the link of the email by the processing module 640 may be setting the link of the email in an icon; and when the user performs an operation for the icon, the link of the email is operated. In this way, the email may be directly checked, replied or forwarded.

According to the embodiment of the present disclosure, all the attachments are acquired, emails corresponding to the attachments are determined, and links of the emails are processed, such that a user is capable of performing operations for the emails via the links. In this way, while the user checks the attachments by using an attachment list, the user is further capable of checking the emails via attachment jumping, such that mutually linking and jumping between the email attachments and the email content, which facilitates user's checking the emails according to the attachments.

FIG. 7 is a schematic structural diagram illustrating an email processing device according to another embodiment of the present disclosure. As illustrated in FIG. 7, the email processing device according to the present disclosure includes: a first acquiring module 610, a determining module 620, a first exhibiting module 630, and a processing module 640. Specific operations of these modules may be referenced to the specific embodiment illustrated in FIG. 6. The determining module 620 includes:

an identifier acquiring module 621, configured to search for identifiers of the emails corresponding to the attachments; wherein

specifically, since each attachment has an identifier of the email to which the attachment pertains, the identifier acquiring module 621 may search for an email identifier of the attachment in an email server; and

an email determining module 622, configured to determine the emails corresponding to the attachments according to the identifiers.

The identifier acquiring module 621 acquires unique identifiers of the emails corresponding to the attachments. Therefore, the email determining module 622 determines which email an attachment pertains according to the unique identifier, which is equivalent to determining the email corresponding to the attachment.

In the embodiment of the present disclosure, the email corresponding to an attachment is determined via an identifier of the email carried by the attachment. As such, the corresponding email may be acquired accurately via the attachment, and accuracy in searching for an email is enhanced.

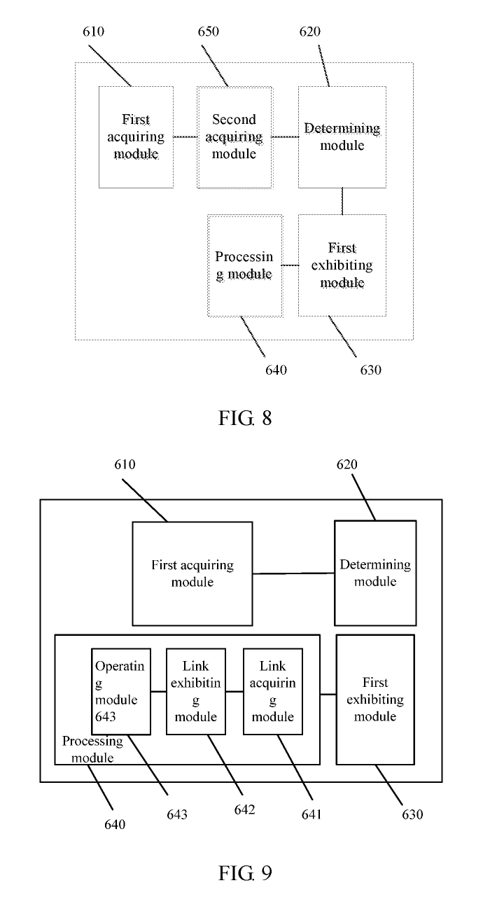

FIG. 8 is a schematic structural diagram illustrating an email processing device according to still another embodiment of the present disclosure. As illustrated in FIG. 8, the email processing device according to the present disclosure includes: a first acquiring module 610, a determining module 620, and a processing module 640. Specific operations of these modules may be referenced to the specific embodiment illustrated in FIG. 6. The email processing device further includes:

a second acquiring module 650, configured to acquire information of the attachments of the emails is acquired, wherein the information includes one or a combination of: names of the attachments, sizes of the attachments, generation dates of the attachments, and senders of the attachments.

The second acquiring module 650 may acquire, via search, the information of the attachments from information stored in an email server, wherein the information may include names of the attachments, sizes of the attachments, generation dates of the attachments, senders of the attachments and the like. Correspondingly, the first exhibiting module 630 exhibits the attachments of all the emails according to a first predetermined manner, or may exhibit in sequence the attachments according to the information acquired by the second acquiring module 650. For example, the attachments may be exhibited in sequence according to the names of the attachments, or may be exhibited in sequence according to the sizes of the attachments, or may be exhibited in sequence according to the senders of the attachments.

In the embodiment of the present disclosure, information of attachments is acquired and the attachments are sequenced according to the information, which more facilitates user's searching for the attachments. In this way, a user is capable of searching for emails according to the attachments, and thus user experience in email use is further improved.

Specifically, in the embodiment of the present disclosure, the first exhibiting module may include: a name sequence-based attachment exhibiting module, configured to exhibit in sequence all the attachments according to the names of the attachments; or a size sequence-based attachment exhibiting module, configured to exhibit in sequence all the attachments according to the sizes of the attachments; or a sender sequence-based attachment exhibiting module, configured to exhibit in sequence all the attachments according to the senders of the attachments; or a date sequence-based attachment exhibiting module, configured to exhibit in sequence all the attachments according to the generation dates of the attachments.

FIG. 9 is a schematic structural diagram illustrating an email processing device according to yet still another embodiment of the present disclosure. As illustrated in FIG. 9, the email processing device according to the present disclosure includes: a first acquiring module 610, a determining module 620, a first exhibiting module 630, and a processing module 640. Specific operations of these modules may be referenced to the specific embodiment illustrated in FIG. 6. The processing module 640 includes:

a link acquiring module 641, configured to acquire the links of the emails corresponding to the attachments;

wherein the link acquiring module 641 may further acquire the links of the emails according to the determined emails. It should be understood that the links of the emails are to entering the links of the emails and thus perform operations for the emails by exhibiting the links of the emails;

a link exhibiting module 642, configured to exhibit the links under items of the exhibited attachments in a predetermined form;

it should be understood that during exhibition of the attachments, all the attachments may be exhibited in a list, and each attachment is exhibited via an attachment item; this item may include various information of the attachment, for example, size of the attachment, reception time of the attachment and the like; the link exhibiting module 642 exhibits the link of the email corresponding to the attachment in the attachment; it is to be noted that in the present disclosure, the links of the emails are not necessarily directly exhibited, which are exhibited in various predetermined manners instead; for example, the user is notified via an icon that clicking the icon helps the user to jump to the link of the email, or such notification may be implemented via text; the present disclosure sets no limitation thereto; and

an operating module 643, configured to, when it is detected that the user performs operations for the emails via the links exhibited in the predetermined form, perform the operations.

The operating module 643, when it is detected that the user performs operations for the emails via the links exhibited in the predetermined form, performs the operations. For example, the link exhibiting module 642 exhibits the links of the emails in the form of icons; and upon acquiring the user's operations for the icons, the operating module 643 performs the operations. Herein the operations may be checking the email, replying the email, forwarding the email or the like.

In the embodiment of the present disclosure, links of emails are exhibited in a predetermined form under attachment items, such that a user is capable of directly checking corresponding emails under items of attachments while checking the attachments. This increases the convenience of the user in checking the emails via the attachments, and improves user experience.

Embodiments of this application provide a non- transitory computer storage medium in which computer executable instructions are stored, wherein the computer executable instructions are used for executing a method for processing an email in any of above-described method embodiments.

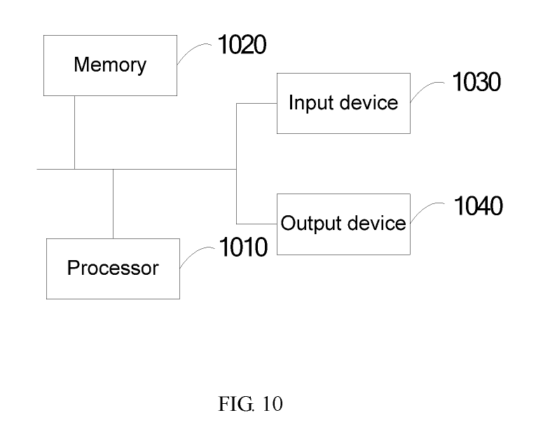

FIG. 10 is a schematic diagram showing a hardware structure of an electronic device performing a method for processing an email provided in the Embodiment of this application, as shown in FIG. 10, the device includes:

at least one processor 1010 and a memory 1020, where one processor 1010 is taken as an example in FIG. 10.

The device for performing the method for processing an email may further include: an input device 1030 and an output device 1040.

The processor 1010, the memory 1020, the input device 1030 and the output device 1040 can be connected by a bus or by other means, and a bus connection is taken as an example in FIG. 10.

The memory 1020, as a non-transitory computer-readable storage medium, can be configured to store a non-transitory software program, a non-transitory computer-executable program and module, such as program instructions/modules (for example, the first acquiring module 610, the determining module 620, the first exhibiting module 630, and the processing module 640 as shown in FIG. 6) corresponding to the method for processing an email in embodiments of this application. The processor 1010 performs various functional applications and data processing in a server by running a non-transitory software program, instruction and module stored in the memory 1020, that is, to implement the method for processing an email according to the above method embodiments.

The memory 1020 may include a storage program area and a storage data area, where the storage program area can store an operating system, and an application program required by at least one function; the storage data area can store data created by use of the apparatus for processing an email and the like. In addition, the memory 1020 may include a high-speed random access memory, or may further include a non-volatile memory such as at least one magnetic disk storage device, a flash memory device, or other non-volatile solid state storage device. In some embodiments, optionally, the memory 1020 may include memories remotely located relative to the processor 1010, and these remote memories can be connected to the apparatus for processing an email through a network. Examples of the above network include but are not limited to an Internet, an intranet, a local area network, a mobile communication network, and any combination thereof.

The input device 1030 can receive input number or character information, and generate key signal input associated with user settings and functional control of the apparatus for processing an email. The output device 1040 may include a display device such as a display screen.

The at least one module is stored in the above memory 1020, when the at least one module is executed by the at least one processor 1010, the at least one module executes the method for processing an email according to any of the method embodiments.

The above product can perform the method provided in embodiments of this application, and have corresponding function modules and beneficial effects. Refer to the method provided in embodiments of this application for technical details, which are not described in detail in this embodiment.

The electronic equipment in embodiments of this application exists in various forms, including but not limited to:

(1) mobile telecommunication device. A device of this kind has a feature of mobile communicating function, and has a main object of providing voice and data communication. Devices of this kind include smart phone (such as iphone®), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad®;

(3) portable entertainment device. A device of this kind can display and play multi-media content. Devices of this kind include audio and video player (such as ipod®), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

The apparatus embodiment described above is merely exemplary. The modules described as separate parts may or may not be physically separate, and the parts displayed as modules may or may not be physical modules, that is, they may be located at one position or may be distributed on a plurality of network modules. Some or all of the modules may be selected according to actual needs to achieve the objective of the solution of this embodiment. Persons of ordinary skill in the art may understand and implement the embodiment without creative efforts.

Through the foregoing description of the implementation manners, persons skilled in the art are clearly aware that the implementation manners may be implemented through software plus a necessary hardware platform, and of course, may also be implemented through hardware. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. An email processing method at an electronic device, comprising:
acquiring attachments of all the emails in a predetermined file folder of an email account;
determining emails corresponding to the attachments;
exhibiting the attachments of all the emails in a first predetermined manner; and
processing links of the emails corresponding to the attachments, such that a user is capable of performing operations for the corresponding emails via the links.

2. The method according to claim 1, wherein the determining emails corresponding to the attachments comprises:
searching for identifiers of the emails corresponding to the attachments; and
determining the emails corresponding to the attachments according to the identifiers.

3. The method according to claim 1, further comprising:
acquiring information of the attachments of the emails, the information comprising one or a combination of: names of the attachments, sizes of the attachments, generation dates of the attachments, and senders of the attachments.

4. The method according to claim 3, wherein the exhibiting the attachments of all the emails in a first predetermined manner comprises:
exhibiting in sequence all the attachments according to the names of the attachments; or
exhibiting in sequence all the attachments according to the sizes of the attachments; or
exhibiting in sequence all the attachments according to the senders of the attachments; or
exhibiting in sequence all the attachments according to the generation dates of the attachments.

5. The method according to any one of claim 1, wherein the processing links of the emails corresponding to the attachments, such that a user is capable of performing operations for the corresponding emails via the links comprises:
acquiring the links of the emails corresponding to the attachments;
exhibiting the links under items of the exhibited attachments in a predetermined form; and
when it is detected that the user performs operations for the emails via the links exhibited in the predetermined form, performing the operations.

6. An email processing device, comprising:
at least one processor; and
a memory communicably connected with the at least one processor for storing instructions executable by the at least one processor, wherein execution of the instructions by the at least one processor causes the at least one processor to:
acquire attachments of all the emails in a predetermined file folder of an email account;
determine emails corresponding to the attachments;
exhibit the attachments of all the emails in a first predetermined manner; and
process links of the emails corresponding to the attachments, such that a user is capable of performing operations for the corresponding emails via the links.

7. The device according to claim 6, wherein the step to determine emails corresponding to the attachments comprises:
searching for identifiers of the emails corresponding to the attachments; and
determining the emails corresponding to the attachments according to the identifiers.

8. The device according to claim 6, wherein the at least one processor is further caused to:
acquire information of the attachments of the emails, the information comprising one or a combination of: names of the attachments, sizes of the attachments, generation dates of the attachments, and senders of the attachments.

9. The device according to claim 8, wherein the step to acquire attachments of all the emails in a predetermined file folder of an email account comprises:
exhibiting in sequence all the attachments according to the names of the attachments; or
exhibiting in sequence all the attachments according to the sizes of the attachments; or
exhibiting in sequence all the attachments according to the senders of the attachments; or
exhibiting in sequence all the attachments according to the generation dates of the attachments.

10. The device according to claim 6, wherein the step to process links of the emails corresponding to the attachments, such that a user is capable of performing operations for the corresponding emails via the links comprises:
acquiring the links of the emails corresponding to the attachments;
exhibiting the links under items of the exhibited attachments in a predetermined form; and
when it is detected that the user performs operations for the emails via the links exhibited in the predetermined form, performing the operations.

11. A non-transitory computer-readable storage medium storing executable instructions that, when executed by an electronic device cause the electronic device to:
acquire attachments of all the emails in a predetermined file folder of an email account;
determine emails corresponding to the attachments;
exhibit the attachments of all the emails in a first predetermined manner; and
process links of the emails corresponding to the attachments, such that a user is capable of performing operations for the corresponding emails via the links.

12. The non-transitory computer-readable storage medium according to claim 11, wherein when determining emails corresponding to the attachments, the executable instructions cause the electronic device to:
search for identifiers of the emails corresponding to the attachments; and
determine the emails corresponding to the attachments according to the identifiers.

13. The non-transitory computer-readable storage medium according to claim 11, the executable instructions further cause the electronic device to:
acquire information of the attachments of the emails, the information comprising one or a combination of: names of the attachments, sizes of the attachments, generation dates of the attachments, and senders of the attachments.

14. The non-transitory computer-readable storage medium according to claim 13, wherein when exhibiting the attachments of all the emails in a first predetermined manner, the executable instructions cause the electronic device to:
exhibit in sequence all the attachments according to the names of the attachments; or
exhibit in sequence all the attachments according to the sizes of the attachments; or
exhibit in sequence all the attachments according to the senders of the attachments; or
exhibit in sequence all the attachments according to the generation dates of the attachments.

15. The non-transitory computer-readable storage medium according to claim 11, wherein when processing links of the emails corresponding to the attachments, such that a user is capable of performing operations for the corresponding emails via the links, the executable instructions cause the electronic device to:
acquire the links of the emails corresponding to the attachments;
exhibit the links under items of the exhibited attachments in a predetermined form; and
when it is detected that the user performs operations for the emails via the links exhibited in the predetermined form, perform the operations.
